(19) United States
(12) Patent Application Publication
(10) Pub. No.: US 2016/0170921 A1
(43) Pub. Date: Jun. 16, 2016

(54) SEMICONDUCTOR INTEGRATED CIRCUIT AND METHOD OF DATA TRANSFER PROCESSING THE SAME

(71) Applicant: Kabushiki Kaisha Toshiba, Tokyo (JP)

(72) Inventors: Yoshihiko Okuda, Kawasaki Kanagawa (JP); Kazuhiko Ohashi, Tokyo (JP); Toshiyuki Okado, Tokyo (JP); Koji Yasuda, Yokohama Kanagawa (JP); Kaduki Ichihara, Kawasaki Kanagawa (JP)

(21) Appl. No.: 14/835,075

(22) Filed: Aug. 25, 2015

(30) Foreign Application Priority Data
Dec. 11, 2014 (JP) 2014-250612

(51) Int. Cl. G06F 13/28; G06F 12/10; G06F 13/16; G06F 11/10

(52) U.S. Cl. CPC G06F 13/28; G06F 11/1016; G06F 12/1081; G06F 13/1694; G06F 2212/656

(57) ABSTRACT

In one embodiment, a semiconductor integrated circuit includes a DMA controller, a memory controller, an arithmetic processing unit, and an integrated control unit. The DMA controller controls transfer of data to a memory and controls transfer of data stored in the memory. The memory controller controls a transfer operation of the DMA controller. The memory controller transfers data stored in a memory unit to the memory or stores data held by the memory in the memory unit. The arithmetic processing unit executes error correction of the data transferred by the DMA controller. The integrated control unit instructs the memory controller to start data transfer, and executes transfer final processing.

### CROSS REFERENCE TO RELATED APPLICATION

This application is based upon and claims the benefit of priority from the prior Japanese Patent Application No. 2014-250612, filed on Dec. 11, 2014, the entire contents of which are incorporated herein by reference.

### FIELD

Embodiments described herein are related to a semiconductor integrated circuit and a method of data transfer processing the same.

### BACKGROUND

In DMA (direct memory access) transfer, a CPU (central processing unit) transmits a transfer request to a DMA controller to start data transfer. When the data transfer is completed, the DMA controller notifies the CPU of completion of the transfer.

In the case where multiple DMA controllers are provided to improve processing capacity, sequential data transfer requires the CPU to control the DMA controllers one after another by successively transmitting transfer requests and doing the like. Hence, there is a problem of consuming the processing capacity of the CPU.

### BRIEF DESCRIPTION OF THE DRAWINGS

FIG. 1 is a block diagram showing a semiconductor integrated circuit according to a first embodiment;

FIG. 2 is a timing chart showing an operation of the semiconductor integrated circuit according to the first embodiment;

FIG. 3 is a block diagram showing a semiconductor integrated circuit according to a second embodiment;

FIG. 4 is a timing chart showing an operation of the semiconductor integrated circuit according to the second embodiment;

FIG. 5 is a block diagram showing a semiconductor integrated circuit according to a third embodiment;

FIG. 6 is a flowchart showing an operation of the semiconductor integrated circuit according to the third embodiment;

FIG. 7 is a block diagram showing a semiconductor integrated circuit according to a fourth embodiment;

FIG. 8 is a diagram showing configurations of descriptor tables according to the fourth embodiment;

FIG. 9 is a timing chart showing an operation of the semiconductor integrated circuit according to the fourth embodiment; and

FIG. 10 is a block diagram showing a semiconductor integrated circuit according to a fifth embodiment.

### DETAILED DESCRIPTION

In one embodiment, a semiconductor integrated circuit includes a DMA controller, a memory controller, an arithmetic processing unit, and an integrated control unit. The DMA controller controls transfer of data to a memory and controls transfer of data stored in the memory. The memory controller controls a transfer operation of the DMA controller. The memory controller transfers data stored in a memory unit to the memory or stores data held by the memory in the memory unit. The arithmetic processing unit executes error correction of the data transferred by the DMA controller. The integrated control unit instructs the memory controller to start data transfer, and executes transfer final processing.

More embodiments will be described below with reference to the drawings. In the drawings, identical reference numerals denote identical or similar portions.

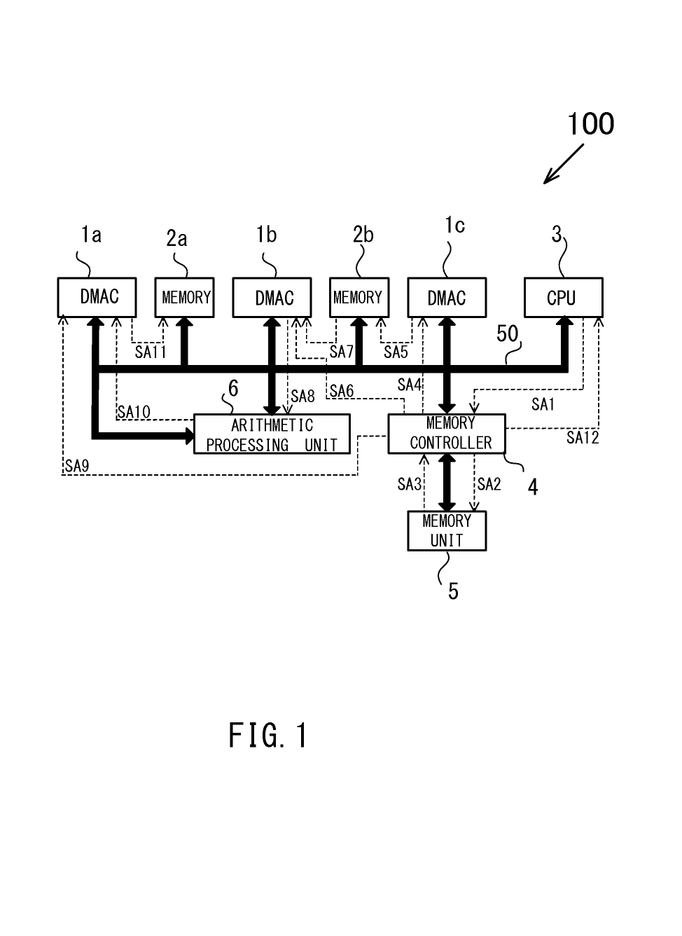

A semiconductor integrated circuit according to a first embodiment will be described with reference to the drawings. FIG. 1 is a block diagram showing a semiconductor integrated circuit. In the first embodiment, a memory controller is used for controlling multiple DMA (direct memory access) controllers, and a load on a CPU (central processing unit) is relieved by reducing the number of instructions from the CPU.

As shown in FIG. 1, a semiconductor integrated circuit 100 includes DMA controllers 1a to 1c, a memory 2a, a memory 2b, a CPU 3, a memory controller 4, a memory unit 5, and an arithmetic processing unit 6. The DMA controllers 1a to 1c, the memory 2a, the memory 2b, the CPU 3, the memory controller 4, and the arithmetic processing unit 6 are electrically connected to one another through a bus 50.

The DMA controllers 1a to 1c control transfer of data stored in the memory 2a and the memory 2b, and control transfer of data to the memory 2a and the memory 2b. The DMA controllers 1a to 1c transfer data stored in the memory unit 5 through the memory controller.

The memory 2a and the memory 2b store data, programs, and the like. Each of the memory 2a and the memory 2b employs an SRAM (static random access memory) or an MRAM (magnetoresistive random access memory), for example.

The CPU 3 (an integrated control unit) performs integrated control of the semiconductor integrated circuit 100. The CPU 3 starts up the memory controller 4 and transmits a data transfer start instruction, for example, to the memory controller 4. Data transfer includes write processing, read processing, and program transfer processing, and encompasses the transfer of the data to the memories and the transfer of the data stored in the memories. The CPU 3 executes the data transfer final processing upon receipt of a data transfer completion signal. Here, although the CPU is used as the integrated control unit, a processor or an MPU (micro processing unit) may be used instead.

The memory controller 4 transmits a data transfer instruction to each of the DMA controllers 1a to 1c based on the data transfer start instruction from the CPU 3. The memory controller 4 transfers the data stored in the memory unit 5 to the DMA controllers. When the data transfer is completed, the memory controller 4 transmits the data transfer completion signal to the CPU 3.

The memory unit 5 stores data, programs, and the like. The memory unit 5 outputs the stored data based on the data transfer instruction from the memory controller 4. Here, although a NAND flash memory is used as the memory unit 5, an SRAM, an SSD (solid state drive), an HDD (hard disc drive), and the like may be used instead.

The arithmetic processing unit 6 executes arithmetic processing of the transferred data such as error correction of the transferred data. Here, the arithmetic processing is executed on the basis of an instruction from the memory controller 4.

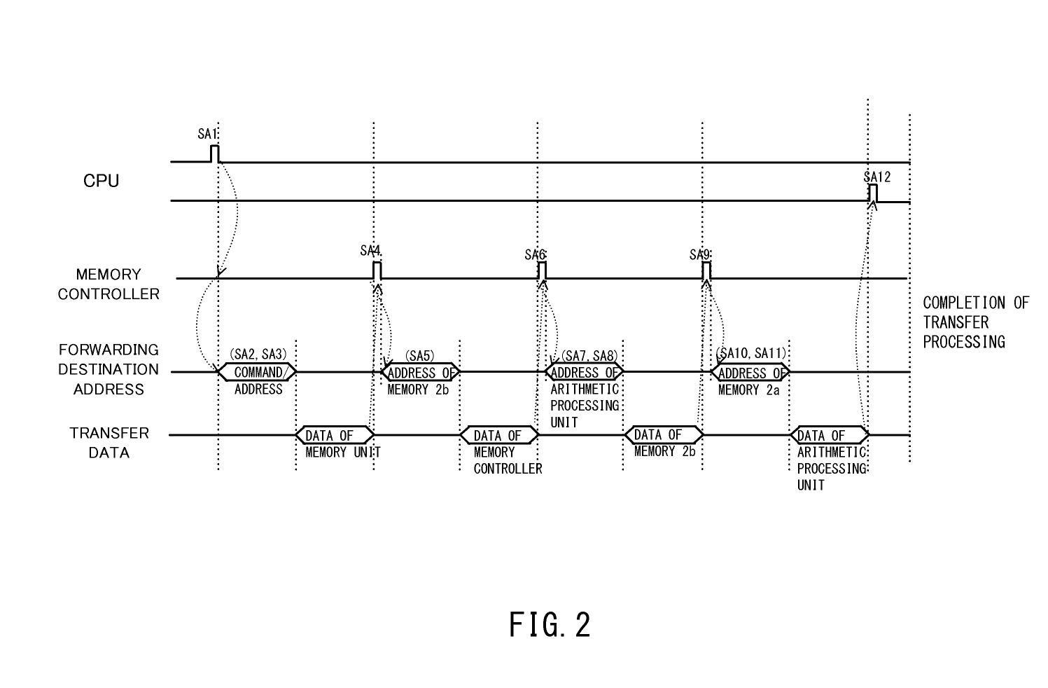

Next, an operation of the semiconductor integrated circuit will be described with reference to FIG. 1 and FIG. 2. FIG. 2 is a timing chart showing the operation of the semiconductor integrated circuit. Here, the data transfer using the memory controller and the DMA controllers will be described.

As shown in FIG. 1 and FIG. 2, the CPU 3 starts up the memory controller 4. The CPU 3 transmits a signal SA1, which represents a request for starting a read sequence involving the memory unit 5, to the memory controller 4.

The memory controller 4 transmits a signal SA2, which represents a read command/address, to the memory unit 5 based on the instruction from the CPU 3. The memory unit 5 transmits a signal SA3, which represents the read data, to the memory controller 4. When the read processing is completed, the memory controller 4 transmits a signal SA4, which represents a data transfer request, to the DMA controller 1c.

The DMA controller 1c transmits a signal SA5, which represents an address of the memory 2b, to the memory 2b based on the instruction from the memory controller 4. The DMA controller 1c transfers the data, which is read out of the memory unit 5 and is transferred through the memory controller, to the memory 2b.

After the transfer processing to the memory 2b is completed, the memory controller 4 transmits a signal SA6, which represents a data transfer request, to the DMA controller 1b.

The DMA controller 1b transfers a signal SA7, which represents data in the memory 2b, based on the instruction from the memory controller 4, and transmits a signal SA8, which represents an address of the arithmetic processing unit 6, to the arithmetic processing unit 6. The DMA controller 1b transfers the data in the memory 2b to the arithmetic processing unit 6. The arithmetic processing unit 6 executes arithmetic processing of the transferred data such as the error correction.

After the arithmetic processing is completed, the memory controller 4 transmits a signal SA9, which represents a data transfer request, to the DMA controller 1a.

The DMA controller 1a transfers a signal SA10, which represents the data in the memory 2b subjected to the arithmetic processing by the arithmetic processing unit 6, based on the instruction from the memory controller 4, and transmits a signal SA11, which represents an address of the memory 2a, to the memory 2a. The DMA controller 1a transfers the data subjected to the arithmetic processing to the memory 2a.

After the data transfer processing is completed, the memory controller 4 transmits a signal SA12 to the CPU 3. The CPU 3 executes transfer final processing of the data in the memory unit 5. Specifically, the CPU 3 enables execution of other transfer processing or processing in the semiconductor integrated circuit 100.

In the first embodiment, the processing to be directly executed by the CPU is the data transfer start instruction to the memory controller 4 and the data transfer final processing.

On the other hand, the load on the CPU is rapidly increased in the case of a semiconductor integrated circuit (not shown) of a comparative example which is not provided with the memory controller 4 and is configured such that the CPU directly instructs the multiple DMA controllers to perform the transfer processing.

Here, a case where 100 clocks are required for reading the data out of the memory unit 5 while 20 clocks are required for performing the data transfer start instruction and the data transfer final processing by the CPU 3 will be considered as an example. In the first embodiment, even when the transfer of the data in the memory unit 5 is repeated 100 times, the CPU 3 consumes only 20 clocks for performing the data transfer start instruction and the data transfer final processing but does not require any clocks in the rest of the processing.

As described above, in the semiconductor integrated circuit of the first embodiment, the semiconductor integrated circuit 100 is provided with the DMA controllers 1a to 1c, the memory 2a, the memory 2b, the CPU 3, the memory controller 4, the memory unit 5, and the arithmetic processing unit 6. The memory controller 4 transmits the data transfer instructions to the DMA controllers 1a to 1c based on the instructions from the CPU 3. The CPU 3 transmits the data transfer start instruction and the data transfer final processing. The CPU 3 does not transmit any data transfer instructions to the DMA controllers 1a to 1c.

Accordingly, it is possible to reduce the load on the CPU 3 while maintaining throughput of the transfer processing.

Although the data in the memory unit 5 is transferred to the memory 2b in the first embodiment, the invention is not limited to the above-described configuration. For example, a program stored in the memory unit 5 or the memory 2b may be transferred or the data in the memory 2b may be written in the memory unit 5.

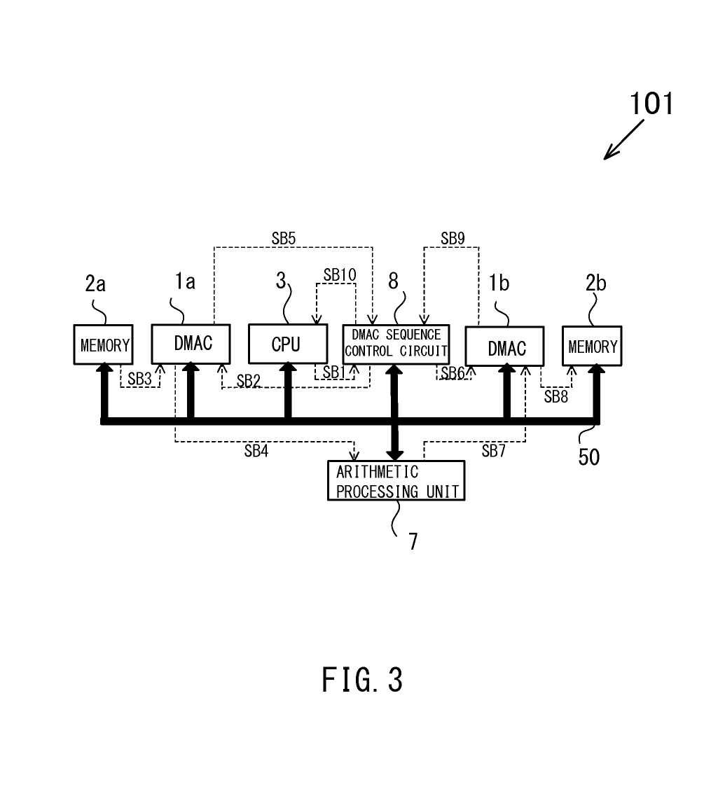

A semiconductor integrated circuit according to a second embodiment will be described with reference to the drawings. FIG. 3 is a block diagram showing a semiconductor integrated circuit. In the second embodiment, the CPU performs a data transfer start instruction to a DMAC (direct memory access controller) sequence control circuit and the DMAC sequence control circuit performs data transfer by DMA controllers. Thus, a load on the CPU is relieved.

In the following, portions which are identical to the portions in the first embodiment will be denoted by identical reference numerals and description of the portions will be omitted. Hence, only different portions will be described below.

As shown in FIG. 3, a semiconductor integrated circuit 101 includes the DMA controller 1a, the DMA controller 1b, the memory 2a, the memory 2b, the CPU 3, an arithmetic processing unit 7, and a DMAC sequence control circuit 8. The DMA controller 1a, the DMA controller 1b, the memory 2a, the memory 2b, the CPU 3, the arithmetic processing unit 7, and the DMAC sequence control circuit 8 are electrically connected to one another through the bus 50.

The arithmetic processing unit 7 executes arithmetic processing of data transferred by the DMA controller 1a and the DMA controller 1b. In addition to the arithmetic processing, the arithmetic processing unit 7 can be also used as a serial input-output circuit.

The DMAC sequence control circuit 8 transmits a data transfer instruction to each of the DMA controller 1a and the DMA controller 1b based on an instruction from the CPU 3.

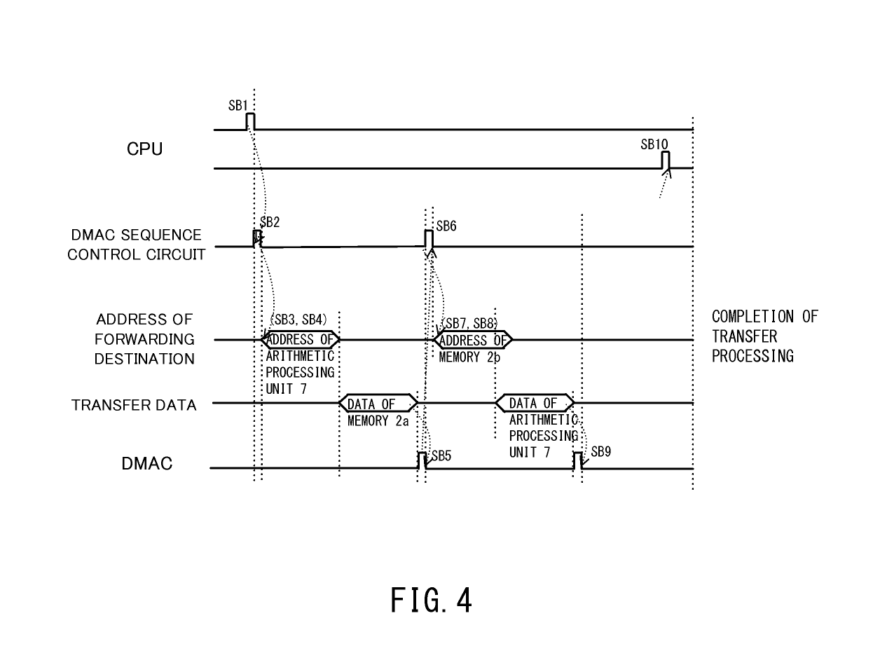

Next, an operation of the semiconductor integrated circuit will be described with reference to FIG. 3 and FIG. 4. FIG. 4 is a timing chart showing the operation of the semiconductor integrated circuit. Here, the DMAC sequence control circuit and the data transfer by the DMA controllers will be described.

As shown in FIG. 3 and FIG. 4, the CPU 3 starts up the DMAC sequence control circuit 8. The CPU 3 transmits a signal SB1, which represents a data transfer start instruction, to the DMAC sequence control circuit 8.

The DMAC sequence control circuit 8 transmits a signal SB2, which represents a data transfer instruction, to the DMA controller 1a based on the instruction from the CPU 3. The DMA controller 1a reads a signal SB3 which represents data in the memory 2a. The DMA controller 1a transmits a signal SB4, which represents a forwarding destination address, to the arithmetic processing unit 7. The DMA controller 1a transfers the data read from the memory 2a to the arithmetic processing unit 7. The arithmetic processing unit 7 performs arithmetic processing of the data transferred from the memory 2a. The DMA controller 1a transmits a signal SB5, which represents completion of transfer of the data read out of the memory 2a, to the DMAC sequence control circuit 8.

After the data transfer is completed, the DMAC sequence control circuit 8 transmits a signal SB6, which represents a data transfer instruction, to the DMA controller 1b. The DMA controller 1b reads a signal SB7 which represents the data processed by the arithmetic processing unit 7. The DMA controller 1b transmits a signal SB8, which represents a forwarding destination address, to the memory 2b. The DMA controller 1b transmits the data read out of the arithmetic processing unit 7 to the memory 2b. The DMA controller 1b transmits a signal SB9, which represents completion of transfer of data read out of the arithmetic processing unit 7, to the DMAC sequence control circuit 8.

After the data transfer is completed, the DMAC sequence control circuit 8 transmits a signal SB10 to the CPU 3. The CPU 3 executes transfer final processing of the data. Specifically, the CPU 3 enables execution of other transfer processing or processing in the semiconductor integrated circuit 101.

As described above, in the semiconductor integrated circuit of the second embodiment, the semiconductor integrated circuit 101 is provided with the DMA controller 1a, the DMA controller 1b, the memory 2a, the memory 2b, the CPU 3, the arithmetic processing unit 7, and the DMAC sequence control circuit 8. The DMAC sequence control circuit 8 transmits the data transfer instructions to the DMA controller 1a and the DMA controller 1b based on the instructions from the CPU 3. The CPU 3 transmits the data transfer start instruction and the data transfer final processing. The CPU 3 does not transmit any data transfer instructions to the DMA controller 1a and the DMA controller 1b.

Accordingly, it is possible to reduce the load on the CPU 3 while maintaining throughput of the transfer processing.

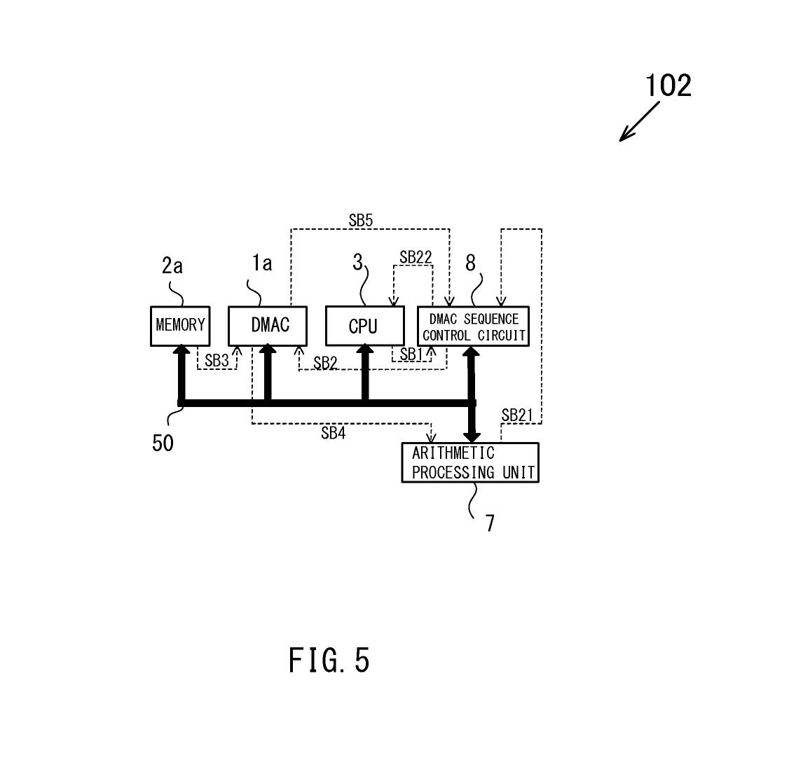

A semiconductor integrated circuit and a method of data transfer processing the same according to a third embodiment will be described with reference to the drawings. FIG. 5 is a block diagram showing a semiconductor integrated circuit. In the third embodiment, the CPU performs a data transfer start instruction to the DMAC sequence control circuit. Meanwhile, only one DMA controller is provided. Moreover, the DMAC sequence control circuit controls data transfer by DMA controller. Thus, a load on the CPU is relieved.

In the following, portions which are identical to the portions in the second embodiment will be denoted by identical reference numerals and description of the portions will be omitted. Hence, only different portions will be described below.

As shown in FIG. 5, a semiconductor integrated circuit 102 includes the DMA controller 1a, the memory 2a, the CPU 3, the arithmetic processing unit 7, and the DMAC sequence control circuit 8. The DMA controller 1a, the memory 2a, the CPU 3, the arithmetic processing unit 7, and the DMAC sequence control circuit 8 are electrically connected to one another through the bus 50.

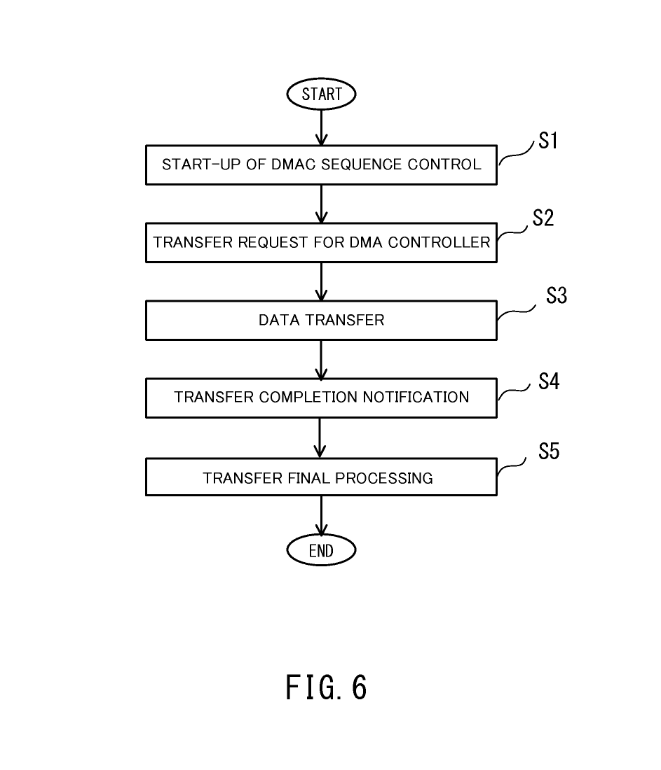

Next, an operation of the semiconductor integrated circuit will be described with reference to FIG. 6. FIG. 6 is a flowchart showing the operation of the semiconductor integrated circuit.

As shown in FIG. 6, the CPU 3 starts up the DMAC sequence control circuit 8. The CPU 3 transmits the signal SB1, which represents the data transfer start instruction, to the DMAC sequence control circuit 8 (step S1).

The DMAC sequence control circuit 8 transmits the signal SB2, which represents the data transfer instruction, to the DMA controller 1a based on the instruction from the CPU 3 (step S2).

The DMA controller 1a reads the signal SB3 which represents the data in the memory 2a. The DMA controller 1a transmits the signal SB4, which represents the forwarding destination address, to the arithmetic processing unit 7. The DMA controller 1a transmits the data read out of the memory 2a to the arithmetic processing unit 7. The arithmetic processing unit 7 performs the arithmetic processing of the transferred data in the memory 2a (step S3).

The arithmetic processing unit 7 transmits a signal SB21, which represents completion of transfer of data read out of the memory 2a, to the DMAC sequence control circuit 8 (step S4).

After the data transfer is completed, the DMAC sequence control circuit 8 transmits a signal SB22 to the CPU 3. The CPU 3 executes the transfer final processing of the data. Specifically, the CPU 3 enables execution of other transfer processing or processing in the semiconductor integrated circuit 102 (step S5).

In the third embodiment, the processing to be directly executed by the CPU is the data transfer start instruction to the DMAC sequence control circuit 8 and the data transfer final processing.

On the other hand, the load on the CPU is rapidly increased in the case of a semiconductor integrated circuit (not shown) of a comparative example which is not provided with the DMAC sequence control circuit 8 and is configured such that the CPU directly instructs the DMA controller to perform the transfer processing.

Here, a case where 100 clocks are required for the data transfer while 20 clocks are required for performing the data transfer start instruction and the data transfer final processing by the CPU 3 will be considered as an example. In the third embodiment, even when the data transfer is repeated 100 times, the CPU 3 consumes only 20 clocks for performing the data transfer start instruction and the data transfer final processing.

As described above, in the semiconductor integrated circuit and the method of data transfer processing the same of the third embodiment, the semiconductor integrated circuit 102 is provided with the DMA controller 1a, the memory 2a, the CPU 3, the arithmetic processing unit 7, and the DMAC sequence control circuit 8. The DMAC sequence control circuit 8 transmits the data transfer instruction to the DMA controller 1a based on the instruction from the CPU 3. The CPU 3 transmits the data transfer start instruction and the data transfer final processing. The CPU 3 does not transmit any data transfer instruction to the DMA controller 1a.

Accordingly, it is possible to reduce the load on the CPU 3 while maintaining the throughput of the transfer processing.

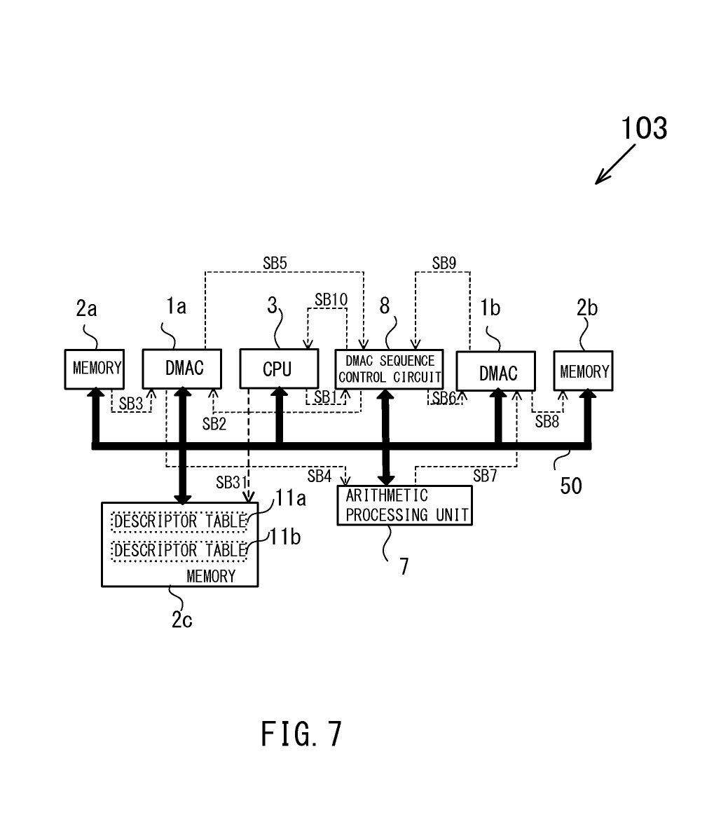

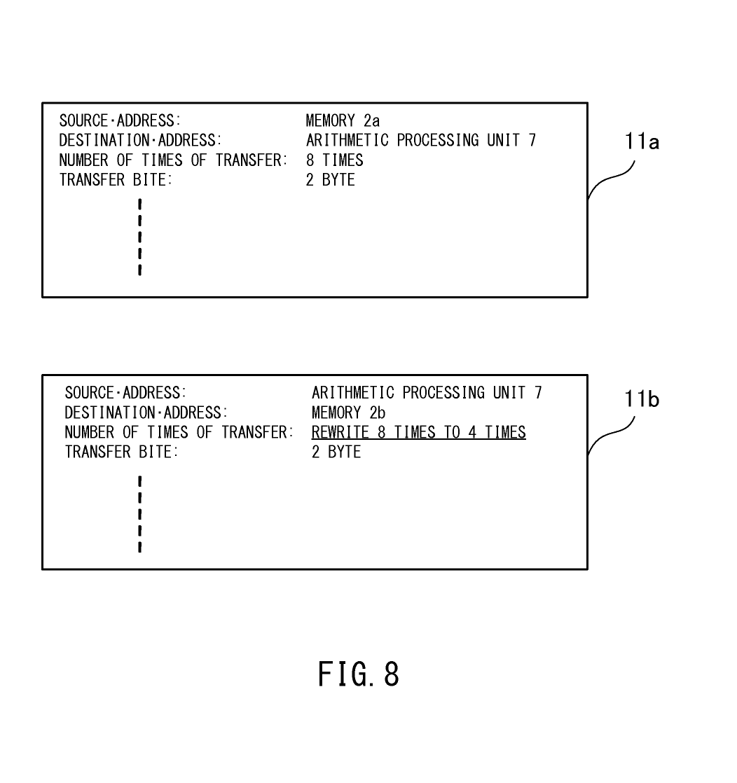

A semiconductor integrated circuit according to a fourth embodiment will be described with reference to the drawings. FIG. 7 is a block diagram showing a semiconductor integrated circuit. FIG. 8 is a diagram showing configurations of descriptor tables. In the fourth embodiment, the CPU rewrites data of descriptor tables stored in a memory.

In the following, portions which are identical to the portions in the second embodiment will be denoted by identical reference numerals and description of the portions will be omitted. Hence, only different portions will be described below.

As shown in FIG. 7, a semiconductor integrated circuit 103 includes the DMA controller 1a, the DMA controller 1b, the memory 2a, the memory 2b, a memory 2c, the CPU 3, the arithmetic processing unit 7, and the DMAC sequence control circuit 8. The DMA controller 1a, the DMA controller 1b, the memory 2a, the memory 2b, the memory 2c, the CPU 3, the arithmetic processing unit 7, and the DMAC sequence control circuit 8 are electrically connected to one another through the bus 50.

The memory 2c includes a descriptor table 11a in which descriptor information on the DMA controller 1a is described, and a descriptor table 11b in which descriptor information on the DMA controller 1b is described.

The CPU 3 rewrites the descriptor information in the descriptor table 11a and the descriptor table 11b during DMA transfer processing. Specific description will be given with reference to FIG. 8. FIG. 8 is the diagram showing configurations of the descriptor tables.

As shown in FIG. 8, each descriptor table describes source address, destination address, number of times of transfer, transfer byte, and the like. In the descriptor table 11a, the source address is the memory 2a, the destination address is the arithmetic processing unit 7, the number of times of transfer is 8 times, and the transfer byte is 2 bytes. In the descriptor table 11b, the source address is the arithmetic processing unit 7, the destination address is the memory 2b, the number of times of transfer is rewritten from 8 times to 4 times by the CPU 3, and the transfer byte is 2 bytes.

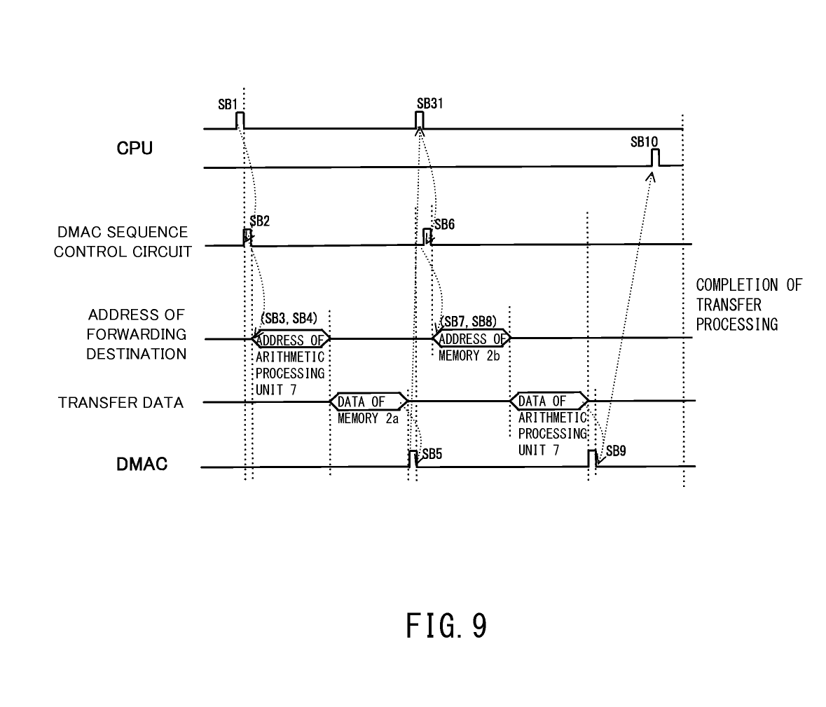

Next, an operation of the semiconductor integrated circuit will be described with reference to FIG. 7 and FIG. 9. FIG. 9 is a timing chart showing the operation of the semiconductor integrated circuit.

Here, the operation other than the rewriting of the descriptor information on the DMA controller 1a by the CPU 3 is the same as the operation in the second embodiment. Accordingly, only portions of the processing different from FIG. 4 will be described.

As shown in FIG. 9, after the signal SB5, which represents completion of transfer of the data read out of the memory 2a, is transmitted to the DMAC sequence control circuit 8, the CPU 3 rewrites the descriptor table in the memory 2c. Specifically, the CPU 3 rewrites the number of times of transfer in the descriptor table 11b from 8 times to 4 times. The rewrite instruction information is also transmitted to the DMAC sequence control circuit 8 (which is not shown).

After the rewriting of the descriptor information is confirmed, the DMAC sequence control circuit 8 transmits the signal SB6, which represents the data transfer instruction, to the DMA controller 1b. The rest of the operation is the same as the operation of the second embodiment and the description will therefore be omitted.

As described above, in the semiconductor integrated circuit of the fourth embodiment, the semiconductor integrated circuit 103 is provided with the DMA controller 1a, the DMA controller 1b, the memory 2a, the memory 2b, the memory 2c, the CPU 3, the arithmetic processing unit 7, and the DMAC sequence control circuit 8. The memory 2c includes the descriptor table 11a and the descriptor table 11b. The CPU 3 rewrites the descriptor information during the DMA transfer processing.

Accordingly, in addition to the effect similar to the effect of the first embodiment, a data transfer mode can be changed in real time.

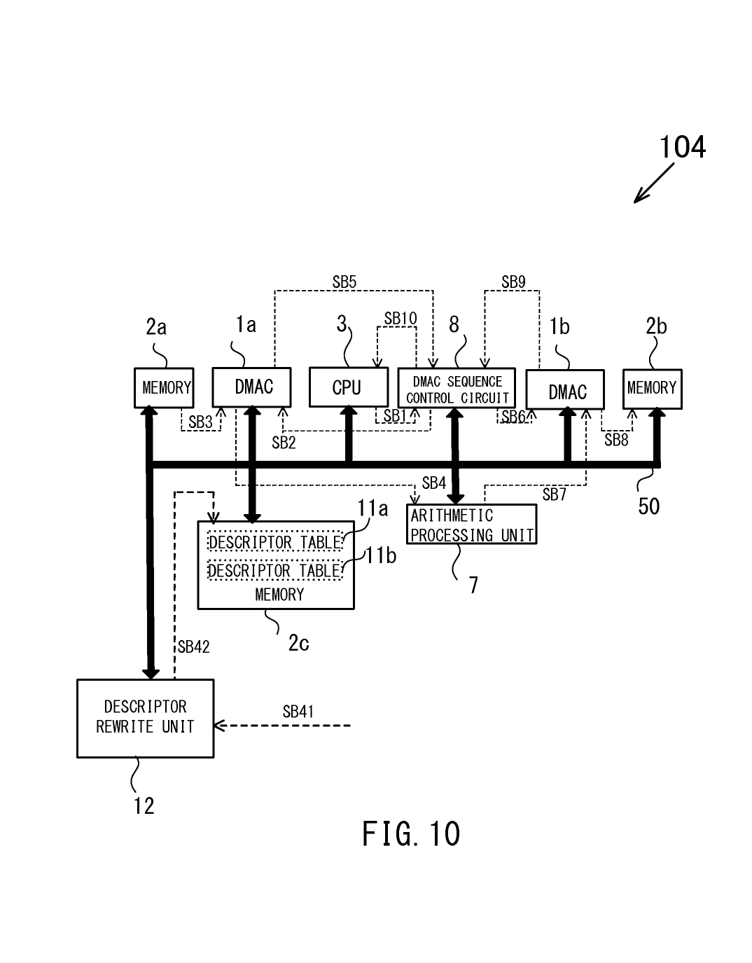

A semiconductor integrated circuit according to a fifth embodiment will be described with reference to the drawing. FIG. 10 is a block diagram showing a semiconductor integrated circuit. In the fifth embodiment, a descriptor rewrite unit rewrites data in the descriptor tables stored in the memory.

In the following, portions which are identical to the portions in the second embodiment will be denoted by identical reference numerals and description of the portions will be omitted. Hence, only different portions will be described below.

As shown in FIG. 10, a semiconductor integrated circuit 104 includes the DMA controller 1a, the DMA controller 1b, the memory 2a, the memory 2b, the memory 2c, the CPU 3, the arithmetic processing unit 7, the DMAC sequence control circuit 8, and a descriptor rewrite unit 12. The DMA controller 1a, the DMA controller 1b, the memory 2a, the memory 2b, the memory 2c, the CPU 3, the arithmetic processing unit 7, the DMAC sequence control circuit 8, and the descriptor rewrite unit12 are electrically connected to one another through the bus 50.

When a signal SB41 representing a descriptor rewrite signal is inputted, the descriptor rewrite unit 12 transmits a signal S42, which represents a rewrite signal for the description information in the memory 2c, to the memory 2c based on the signal SB41. The descriptor information in the memory 2c is rewritten based on the signal SB42. The descriptor rewrite unit 12 notifies the CPU 3 and the DMAC sequence control circuit 8 of the fact that the rewrite processing has been executed. The operation other than the above-mentioned rewrite processing of the descriptor information is the same as the operation of the second embodiment and the description will therefore be omitted.

As described above, in the semiconductor integrated circuit of the fifth embodiment, the semiconductor integrated circuit 104 is provided with the DMA controller 1a, the DMA controller 1b, the memory 2a, the memory 2b, the memory 2c, the CPU 3, the arithmetic processing unit 7, the DMAC sequence control circuit 8, and the descriptor rewrite unit 12. The memory 2c includes the descriptor table 11a and the descriptor table 11b. The descriptor rewrite unit 12 rewrites the descriptor information during the DMA transfer processing.

Accordingly, in addition to the effect similar to the effect of the first embodiment, the data transfer mode can be changed in real time.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor integrated circuit comprising:
a DMA controller configured to control data transfer to a memory, and to control transfer of data stored in the memory;
a memory controller configured to control a transfer operation of the DMA controller, and to perform any of transfer of the data stored in a memory unit to the memory and storage of the data held by the memory in the memory unit;
an arithmetic processing unit configured to execute error correction of the data transferred by the DMA controller; and
an integrated control unit configured to instruct the memory controller to start data transfer, and to execute transfer final processing.

2. The semiconductor integrated circuit according to claim 1, wherein
the integrated control unit rewrites a descriptor table of the DMA controller stored in the memory.

3. The semiconductor integrated circuit according to claim 2, wherein
the descriptor table includes source address, destination address, number of times of transfer, and transfer byte.

4. The semiconductor integrated circuit according to claim 2, wherein the integrated control unit rewrites the descriptor information during DMA transfer processing.

5. The semiconductor integrated circuit according to claim 1, further comprising:
a descriptor rewrite unit configured to rewrite a descriptor table of the DMA controller stored in the memory.

6. The semiconductor integrated circuit according to claim 5, wherein the descriptor rewrite unit rewrites the descriptor information during DMA transfer processing.

7. The semiconductor integrated circuit according to claim 1, comprising:
a plurality of the DMA controllers, wherein
immediately after a first one of the DMA controllers executes data transfer processing, a second one of the DMA controllers executes data transfer.

8. The semiconductor integrated circuit according to claim 1, wherein the integrated control unit refrains from transmitting a data transmission instruction to the DMA controller.

9. The semiconductor integrated circuit according to claim 1, wherein the integrated control unit is any one of a CPU, an MPU, and a processor.

10. The semiconductor integrated circuit according to claim 1, wherein the data transfer to the memory comprises:
write processing;
read processing; and
program transfer processing.

11. A semiconductor integrated circuit comprising:
a DMA controller configured to control data transfer to a memory, and to control transfer of data stored in the memory;
a DMAC sequence control circuit configured to control a transfer operation of the DMA controller; and
an integrated control unit configured to instruct the DMAC sequence control circuit to start data transfer, and to execute transfer final processing.

12. The semiconductor integrated circuit according to claim 11, wherein
the integrated control unit rewrites a descriptor table of the DMA controller stored in the memory.

13. The semiconductor integrated circuit according to claim 12, wherein
the descriptor table includes source address, destination address, number of times of transfer, and transfer byte.

14. The semiconductor integrated circuit according to claim 11, further comprising:
a descriptor rewrite unit configured to rewrite a descriptor table of the DMA controller stored in the memory.

15. The semiconductor integrated circuit according to claim 11, comprising:
a plurality of the DMA controllers, wherein
immediately after a first one of the DMA controllers executes data transfer processing, a second one of the DMA controllers executes data transfer.

16. The semiconductor integrated circuit according to claim 11, wherein the integrated control unit refrains from transmitting a data transmission instruction to the DMA controller.

17. The semiconductor integrated circuit according to claim 11, wherein the integrated control unit is any one of a CPU, an MPU, and a processor.

18. The semiconductor integrated circuit according to claim 11, further comprising:
an arithmetic processing unit configured to perform arithmetic processing of the data transferred by the DMA controller.

19. A method of data transfer processing a semiconductor integrated circuit comprising the steps of:
starting up a DMAC sequence control circuit based on an instruction from a CPU;
causing the DMAC sequence control circuit to transmit a data transfer request to a DMA controller;
causing the DMA controller to control any of data transfer to a memory and transfer of data stored in the memory;
causing the DMAC sequence control circuit to receive transfer completion notification from the DMA controller; and
causing the CPU to execute transfer final processing.
